(19) United States
(12) Patent Application Publication
(10) Pub. No.: US 2023/0313389 A1
(43) Pub. Date: Oct. 5, 2023

(54) APPARATUS AND METHOD FOR THE ELECTROLYTIC PRODUCTION OF HYPOCHLOROUS ACID

(71) Applicant: GROUPE OXWELL INC., Sherbrooke (CA)

(72) Inventors: Ihsen Ben Salah, Sherbrooke, QC (CA); Mohamed Laaroussi, Sherbrooke, QC (CA)

(21) Appl. No.: 18/043,076

(22) PCT Filed: Aug. 30, 2021
(86) PCT No.: PCT/CA2021/051198

§ 371 Date: Feb. 27, 2023

(30) Foreign Application Priority Data
Aug. 31, 2020 (CA) 3091549

(51) Int. Cl. C25B 1/26; C01B 11/04; A01N 59/00; A01P 1/00

(52) U.S. Cl. CPC C25B 1/26; C01B 11/04; A01N 59/00; A01P 1/00

(57) ABSTRACT

An apparatus assembly and method for the electrolytic production of a hypochlorous (HOCl) acid solution are disclosed. A first controlled amount of water, such as tap water, a second controlled amount of an acidic solution (acetic acid or CH₃COOH), and a third controlled amount of a sodium chloride (NaCl) solution, preferably from a brine solution, are mixed by injecting the same in a reaction loop comprising an electrolytic reactor configured to electrolyze the mixture into the HOCl solution. Preferably, the electrolytic reactor comprises DSA (dimensionally stable anodes). The mixture is circulated in the reaction loop until the HOCl solution is formed. The assembly can be monitored in real-time and remotely for quality control. The disinfecting solution as produced comprises 330-460 ppm HOCl at a pH between 5 and 6, preferably at a pH of 5.5, the solution being stable at least up to 6 months after being produced.

### CROSS-REFERENCE TO RELATED APPLICATIONS

The present patent application claims the benefits of priority of Canadian Patent Application No. 3,091,549 entitled “APPARATUS AND METHOD FOR THE ELECTROLYTIC PRODUCTION OF HYPOCHLOROUS ACID”, and filed at the Canadian Intellectual Property Office on Aug. 31, 2021, the content of which is incorporated herein by reference.

### FIELD OF THE INVENTION

The present invention relates to apparatuses and methods for the electrolytic production of hypochlorous acid (HOCl), and the stable HOCl solution as produced.

### BACKGROUND OF THE INVENTION

With the emergence of the COVID-19 pandemic caused by severe acute respiratory syndrome coronavirus 2 (SARS-CoV-2), health care providers have been trying to limit and control the spread of the virus between themselves and patients. Furthermore, the return of employees to their workplace with the reopening of the economy will require a large quantity of readily available, inexpensive, nontoxic, and practical disinfectant that is effective against pathogens, such as the COVID-19 virus.

Hypochlorous acid (HOCl) is a relatively inexpensive, nontoxic, noncorrosive, and well-studied compound. HOCl has been shown to inactivate a variety of viruses, including coronaviruses in less than 1 minute. More importantly, Health Canada and the US Environmental Protection Agency (EPA) recommends hypochlorous acid (HOCl) as a disinfectant against SARS-CoV-2 (COVID-19).

HOCl is known as an endogenous substance produced by white blood cells of our immune system to fight off infections and is effective against a broad range of microorganisms. Since HOCl kills microbes without leaving behind harmful residues and is safe for humans and animals to consume, HOCl is used for preserving fresh produce and disinfect drinking water. HOCl provides a unique power to eradicate dangerous organisms without causing harm since it is one of the only known agents that is both lethal to almost all known dangerous bacteria and viruses that threaten human health while being nontoxic to mammalian cells. HOCl is also known as a powerful oxidizing agent. In aqueous solution, it dissociates into H⁺ and OCl⁻, denaturing and aggregating proteins. HOCl also destroys viruses by forming chloramines and nitrogen-centered radicals, resulting in DNA breaks, thereby inactivating the virus.

There are three forms of free chlorine: chlorine gas (Cl₂), hypochlorous acid (HOCl) and hypochlorite (ClO⁻). A chlorinated solution at 25° C. with a pH below 3 will release the majority of its chloride as free chlorine gas. At a pH above 7.5, more than 50% will be in solution as hypochlorite ions (ClO⁻) with the hypochlorite concentration increasing along with the pH. At pH ranging from about 4 to 6, the majority of the chloride is in the hypochlorous acid form (HOCl). Thus, one of the challenges in making and storing hypochlorous acid solutions is maintaining the pH in the correct range to maintain the efficacy of the solution against pathogens.

Current industry practice for the production of sodium hypochlorite is mixing Cl₂ (gas) with an aqueous solution of sodium hydroxide (caustic soda=NaOH) which might be hazardous.

Also, a major disadvantage of HOCl is its relatively short shelf life, since HOCl is effective for up to 2 weeks under ideal conditions.

The object of the invention is to provide an apparatus assembly and a method for the production of HOCl, on-site and on-demand, with a variable scale of production from small to large scaled production.

### SUMMARY OF THE INVENTION

The shortcomings of the prior art are generally mitigated by an apparatus and a method for the production of hypochlorous acid, combining the use of a specific aqueous solution of sodium chloride and the electrolysis reaction of this solution using an electrolytic reactor.

The invention is first directed to an apparatus assembly for the electrolytic production of a hypochlorous acid (HOCl) solution from water, an acidic solution and a sodium chloride (NaCl) solution. The apparatus assembly comprises an electrolytic reactor having an electrically powered electrode assembly inside a reaction chamber; and a loop pump fluidly connected to the reaction chamber such as to form a reaction loop with the electrolytic reactor. The reaction loop is configured to receive the water, the acidic solution and the sodium chloride solution which are mixed together therein; and the electrolytic reactor is configured to electrolyze the mixture of water, acidic solution and the sodium chloride solution through the reaction chamber to form the HOCl solution.

According to a preferred embodiment, the apparatus assembly as defined herein may further comprise a control unit operatively connected to the loop pump for controlling a flow of the mixture circulating in the reaction loop. Preferably, the control unit is configured to be operatively connected to a remote-control system for providing distant monitoring capabilities.

According to a preferred embodiment, the electrolytic reactor of the apparatus assembly as defined herein is a vertical reactor having the electrode assembly comprising at least one anode and at least one cathode operatively connected to a first electric power supply providing a continuous current to the at least one anode, the vertical reactor having an inlet located adjacent a bottom section of the reaction chamber and an outlet located adjacent a top section of the reaction chamber, the mixture of water, acidic solution and sodium chloride solution circulating from the bottom section to the top section of the reaction chamber.

According to a preferred embodiment, the reaction loop of the apparatus assembly as defined herein may further comprise a loop tank fluidly connected to the inlet and outlet of the reactive chamber, the loop tank being configured in size to contain at least a first controlled amount of water, a second controlled amount of the acidic solution and a third controlled amount of the NaCl solution.

According to a preferred embodiment, the apparatus assembly as defined herein may further comprise a reactive tank assembly comprising at least one reactive tank fluidly connected to the reaction loop via at least one reactive dosing pump for providing the second controlled amount of acidic solution, the third controlled amount of NaCl solution or a mixture thereof. Preferably, the reactive tank assembly is fluidly connected to the loop tank of the reaction loop for injecting the second and third controlled amounts of acidic and NaCl solutions in the loop tank.

According to a preferred embodiment, the at least one reactive tank of the reactive tank assembly is located below the electrolytic reactor.

According to a preferred embodiment, the reactive tank assembly may comprise an acid tank fluidly connected to the reaction loop via an acid dosing pump for providing the second controlled amount of acidic solution; and a salt tank fluidly connected to the reaction loop via a salt dosing pump for providing the third controlled amount of NaCl solution.

According to a preferred embodiment, the apparatus assembly as defined herein may further comprise a control unit operatively connected to the at least one reactive dosing pump for controlling an amount of the second controlled amount of acidic solution, an amount of the third controlled amount of NaCl solution injected into the reaction loop, and/or an amount of a mixture thereof.

According to a preferred embodiment, the apparatus assembly as defined herein may further comprise a pH probe operatively connected to the reaction loop for monitoring a pH of the mixture circulating in the reaction loop permitting assessment of a concentration of HOCl in the HOCl solution.

According to a preferred embodiment, the acidic solution comprises acetic acid (CH₃COOH).

According to a preferred embodiment, the apparatus assembly as defined herein may be configured in size for enclosure in a cabinet for safe storage and/or transport thereof. Preferably, the cabinet comprises a chimney fluidly connected to the reaction loop for evacuating gas outside the cabinet. Also, the cabinet may preferably comprise a water inlet, fluidly connected to the reaction loop for providing water to the reaction loop. More preferably, the water inlet is connected to a communal water system for providing tap water to the reaction loop.

According to a preferred embodiment, the reaction loop may comprise a number N of electrolytic reactors, with N≥2, disposed in a parallel configuration and/or in series, the number N being determined in accordance with a volume of HOCl solution to be produced.

According to a preferred embodiment, the electrode assembly of the electrolytic reactor comprises at least one dimensionally stable anode (DSA).

The invention is also directed to a method for the electrolytic production of a hypochlorous acid (HOCl) solution from water, an acidic solution and a sodium chloride (NaCl) solution. The method comprises mixing a first controlled amount of water, a second controlled amount of the acidic solution and a third controlled amount of the sodium chloride (NaCl) solution by injecting the same in a reaction loop comprising an electrolytic reactor configured to electrolyze the mixture into the HOCl solution. The method also comprises circulating the mixture in the reaction loop and the electrolytic reactor where the HOCl solution is formed.

According to a preferred embodiment, the method as defined herein may further comprise: controllably activating, by a control unit, one or more pumps for mixing the first, second and third controlled amounts.

According to a preferred embodiment, the method as defined herein may further comprise: mixing the second controlled amount of the acidic solution and a third controlled amount of the sodium chloride (NaCl) solution before injecting the same in the reaction loop.

According to a preferred embodiment, the method as defined herein may further comprise: measuring a pH of the mixture circulating in the reaction loop.

According to a preferred embodiment, the method as defined herein may further comprise: computing, by the control unit, the concentration of HOCl in the reaction loop based on the measured pH of the mixture.

According to a preferred embodiment, the method as defined herein may further comprise: stopping the circulation of the mixture in the reaction loop when a given concentration of HOCl has been reached. Preferably, the given concentration of HOCl is obtained at a pH between 5 and 6, more preferably at a pH of about 5.5.

According to a preferred embodiment, the acidic solution comprises acetic acid (CH₃COOH). Preferably, the controlled amount of acidic solution comprises from to 2 to 5 ml of a 10% acetic acid solution per liter of water in the reaction loop. More preferably, the controlled amount of acidic solution comprises about 7 ml of a 10% acetic acid solution per liter of water in the reaction loop.

According to a preferred embodiment, the third controlled amount of NaCl solution is obtained from a brine solution for providing an equivalent of from 2 to 5 g of NaCl per liter of water in the reaction loop. Preferably, the brine solution provides an equivalent of about 5 g of NaCl per liter of water in the reaction loop.

According to a preferred embodiment, the method as defined herein may further comprise: storing the HOCl solution as produced in a loop tank fluidly connected to the reaction loop for use of the HOCl solution as a disinfecting solution.

According to a preferred embodiment, the method as defined herein may further comprise: remotely monitoring a pH of the mixture circulating in the reaction loop through a network interface.

According to a preferred embodiment, the method as defined herein may further comprise: remotely monitoring a flow of the mixture circulating in the reaction loop through a network interface.

The invention is yet further directed to an apparatus assembly for producing a hypochlorous acid (HOCl) solution comprising an electrolytic reactor comprising an inlet and an outlet. The assembly comprises a first tank fluidly connected to the inlet of the reactor, the first tank being configured to receive and contain a first controlled amount of an aqueous solution; a second tank fluidly connected to the first tank and configured for providing a second controlled amount of an acidic solution to the first tank; and a third tank fluidly connected to the first tank and configured for providing a third controlled amount of a brine solution to the first tank. The outlet of the at least one reactor is also fluidly connected to the first tank, forming as such a reaction loop in which the first controlled amount of an aqueous solution, the second controlled amount of brine solution and the third controlled amount of acidic solution received by the first tank are mixed together while circulating inside the reaction loop forming as such a reactive solution which then reacts while circulating through the at least one electrolytic reactor to form the HOCl solution until the HOCl solution is produced at a given concentration of HOCl.

The invention is yet further directed to disinfecting solution comprising the HOCl solution produced with the apparatus assembly as disclosed herein, or by the method as disclosed herein. Preferably, the disinfecting solution is a solution comprising 330-460 ppm HOCl at pH 5,5-6, the solution being stable at least up to 6 months after being produced. Preferably, a stable composition corresponds to a diminution of the HOCl concentration up to about 10% over a period of time of 6 months.

The invention is yet further directed to a business method comprising at least: renting by a provider of the apparatus assembly as disclosed herein to a client in need of said apparatus assembly for producing on site HOCl, and monitoring the production of HOCl solution and/or the maintenance of the apparatus assembly by said provider with a computer at a remote distance.

Advantageously, the present invention allows for the electrolytic production of a hypochlorous acid (HOCl) solution starting from only three non-hazardous reactive components: water (e.g. tap water), sodium chloride (NaCl) and an acid (e.g. CH₃COOH found in vinegar). By providing controlled amounts of water, a acidic solution and a NaCl solution to a reaction loop, a HOCl solution with concentration levels of HOCl equivalent to HOCl solutions currently on the market can be safely produced with little oversight from the user. This is due to the reaction loop that provides an internal quality control mechanism for the resulting HOCl solution that will continue to re-enter the reactor until the desired concentration of HOCl is achieved.

Since one model of the apparatus assembly of the present invention can be relatively compact, for instance as being the size of a refrigerator, HOCl solution can be safely made on-site where readily available.

Also, the size of the apparatus can be easily changed (increased) by adding several electrolytic reactors in parallel or in series, in order to increase the production. As the apparatus assembly can be adapted to various workplace settings, employers will be able to lower the costs associated with disinfecting their workplace to limit the spread of various pathogens.

The apparatus assembly may be monitored in real-time to track the quality of HOCl production. Various parameters may be remotely monitored and transmitted to various electronic devices such as computers and smartphones using for instance the Internet. The apparatus assembly may also be monitored remotely using various sensors, computer software and smartphone applications for scheduling preventive maintenance appointments.

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a schematic illustration of the apparatus assembly according to a preferred embodiment of the invention with one reactive tank;

FIG. 2 is a schematic illustration of the apparatus assembly according to a preferred embodiment of the invention with an acid tank and a salt tank;

FIG. 3 is a perspective view of an apparatus assembly according to preferred embodiments;

FIG. 4A is a front view of the apparatus illustrated in FIG. 3;

FIG. 4B is a side view of the apparatus illustrated in FIGS. 3 and 4A;

FIG. 5 shows a producing station for the production of hypochlorous acid solutions comprising six reactors according to preferred embodiments;

FIG. 6 shows another producing station for the production of hypochlorous acid solutions comprising 48 reactors according to preferred embodiments;

FIG. 7 is a flowchart illustrating the method according to a preferred embodiment of the invention; and

FIG. 8 is a modular view of an exemplary system for production of hypochlorous acid in accordance with the teachings of the present invention.

### DETAILED DESCRIPTION OF PREFERRED EMBODIMENTS

A novel apparatus assembly and method for the production of hypochlorous acid will be described hereinafter. Although the invention is described in terms of specific illustrative embodiments, it is to be understood that the embodiments described herein are by way of example only and that the scope of the invention is not intended to be limited thereby.

The terminology used herein is in accordance with definitions set out below.

As used herein % or wt. % means weight % unless otherwise indicated. When used herein % refers to weight % as compared to the total weight percent of the phase or composition that is being discussed.

By “about”, it is meant that the value of weight % (wt. %), time, length, volume or temperature can vary within a certain range depending on the margin of error of the method or device used to evaluate such weight %, time, length, volume or temperature. A margin of error of 10% is generally accepted.

By “stable”, it is meant that the HOCL solution produced by the present invention has a HOCl concentration that remains almost constant over 6 months after the production thereof The term “stable” encompasses a diminution of the HOCl concentration of about 10% over a period of time of 6 months.

The description which follows, and the embodiments described therein are provided by way of illustration of an example of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals or signs.

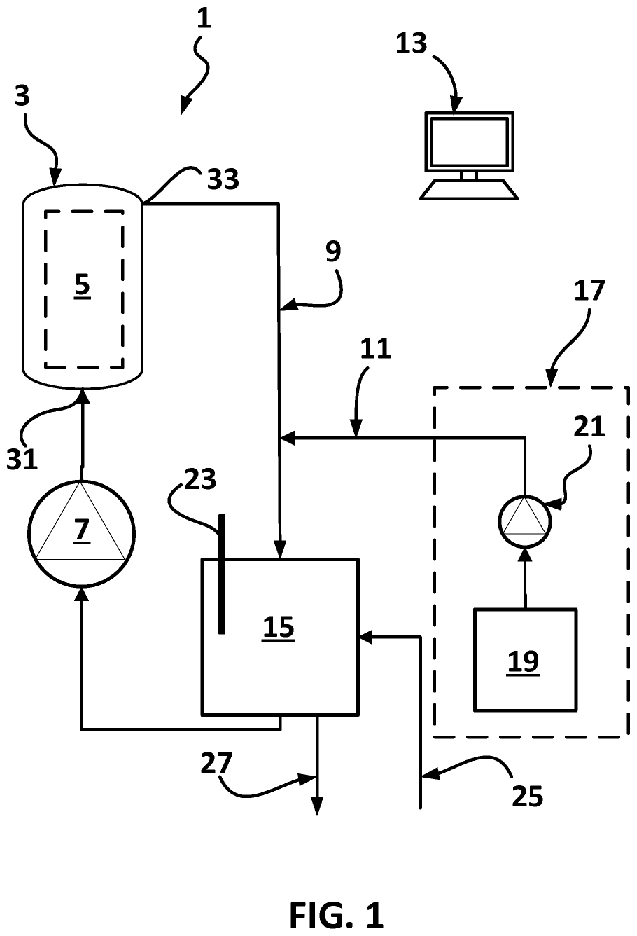

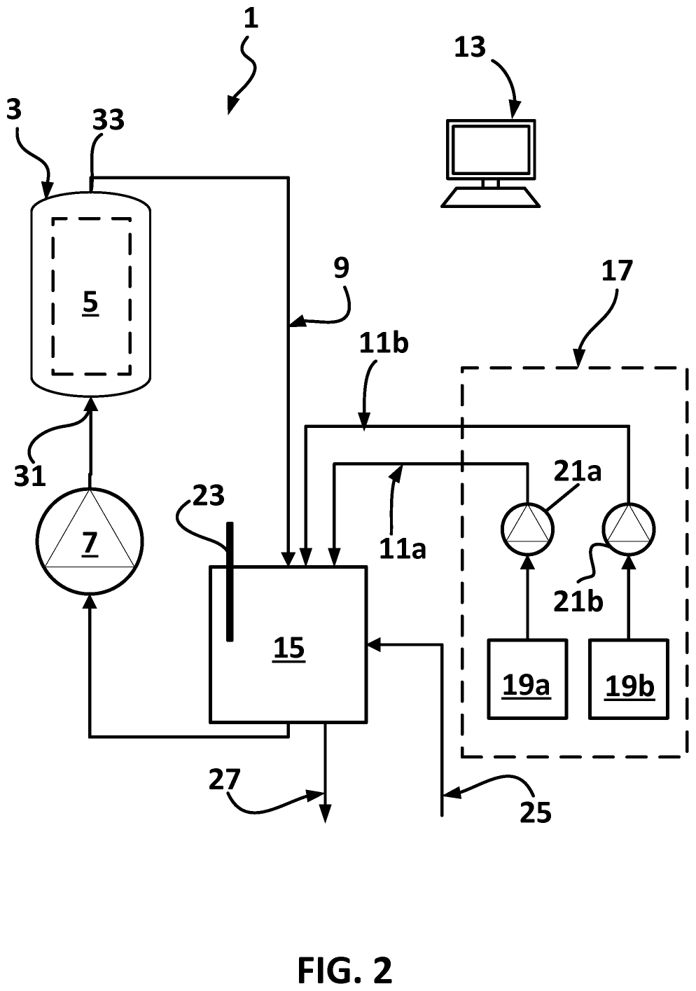

FIGS. 1 and 2 schematically illustrate apparatus assemblies for the electrolytic production of a hypochlorous acid (HOCl) solution from water, an acidic solution and a sodium chloride (NaCl) solution according to a first and second embodiment of the invention.

The apparatus assembly 1 comprises an electrolytic reactor 3 having an electrically powered electrode assembly inside a reaction chamber 5.

The apparatus assembly 1 also comprises a loop pump 7 fluidly connected to the reaction chamber 5 such as to form a reaction loop 9 with the electrolytic reactor 3. The reaction loop 9 is configured to receive the water, the acidic solution and the sodium chloride solution 11 which are mixed together therein. The electrolytic reactor 3 is configured to electrolyze the mixture of water, acidic solution and the sodium chloride solution through the reaction chamber 5 to form the HOCl solution.

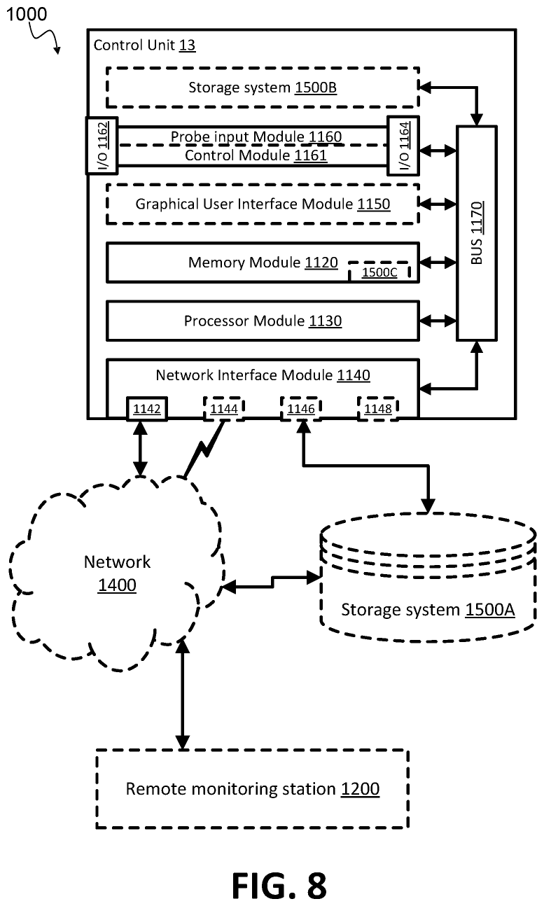

According to a preferred embodiment, the apparatus assembly 1 may further comprise a control unit 13 operatively connected (not shown on FIGS. 1 and 2) to the loop pump 7 for controlling a flow of the mixture circulating in the reaction loop 9. Preferably, the control unit 13 is configured to be operatively connected (not shown on FIGS. 1 and 2) to a remote-control system (not shown on FIGS. 1 and 2) for providing distant monitoring capabilities (e.g., see FIG. 8).

According to a preferred embodiment, the electrolytic reactor 3 of the apparatus assembly is a vertical reactor known as ECOTHOR®, developed by the Applicant and previously described in U.S. Pat. No. 10,968,120 B2 (Ben Salah et al.), the content of which is enclosed herewith by reference. Another model of reactor, recently developed by the Applicant for another application, can also be used. This other reactor is disclosed in WO 2021/151195 A1 (Ben Salah et al.) filed on Jan. 27, 2021, the content of which being also enclosed herewith by reference.

The electrode assembly comprising at least one anode and at least one cathode operatively connected to a first electric power supply providing a continuous current to the at least one anode. The at least one anode is preferably a dimensionally stable anode (DSA). Since the polarity of the reactor may be reversed, the cathode may also be a DSA.

The vertical reactor has an inlet 31 located adjacent a bottom section of the reaction chamber and an outlet 33 located adjacent a top section of the reaction chamber, the mixture of water, acidic solution and sodium chloride solution then circulating from the bottom section to the top section of the reaction chamber 5.

According to a preferred embodiment, the reaction loop of the apparatus assembly as defined herein may further comprise a loop tank 15 fluidly connected to the inlet 31 and outlet 33 of the reactive chamber, the loop tank being configured in size to contain at least a first controlled amount of water, a second controlled amount of the acidic solution and a third controlled amount of the NaCl solution.

According to the preferred embodiment illustrated on FIG. 1, the apparatus assembly 1 further comprises a reactive tank assembly 17 comprising at least one reactive tank 19 fluidly connected to the reaction loop 9 via at least one reactive dosing pump 21 for providing a mixture of the second controlled amount of acidic solution and the third controlled amount of NaCl solution. Preferably, the reactive tank assembly is fluidly connected to the loop tank 15 of the reaction loop for injecting the second and third controlled amounts of acidic and NaCl solutions directly in the loop tank (see e.g. FIG. 2).

According to the preferred embodiment shown in the FIGS. 1 and 2, the reactive tank 19 of the reactive tank assembly is located below the electrolytic reactor 3 for safety sake.

According to the preferred embodiment illustrated on FIG. 2, the reactive tank assembly 17 may comprise two different tanks: a first acid tank 19a fluidly connected to the reaction loop 11a via an acid dosing pump 21a for providing the second controlled amount of acidic solution; and a second salt tank 19b fluidly connected to the reaction loop 11b via a salt dosing pump 21b for providing the third controlled amount of NaCl solution.

The control unit 13 can therefore be operatively connected (not shown on FIG. 1 or 2) to the reactive dosing pumps 21, 21a, 21b for controlling an amount of the second controlled amount of acidic solution, an amount of the third controlled amount of NaCl solution injected into the reaction loop, and/or an amount of a mixture thereof

According to a preferred embodiment, the apparatus assembly as defined herein may further comprise a pH probe 23 operatively connected to the reaction loop, preferably to the loop tank where the HOCl solution accumulates as shown on FIGS. 1 and 2, for monitoring the pH of the mixture circulating in the reaction loop permitting assessment of a concentration of HOCl in the HOCl solution.

As illustrated on FIGS. 1 and 2, the apparatus assembly 1 comprises a water inlet 25, preferably directly connected to a communal water system for providing tap water to the reaction loop. Preferably, the water inlet extends from the loop tank for directly proving water to the loop tank. The loop tank further comprises a main outlet 27 for providing the HOCl solution once produced directly from the loop tank 15.

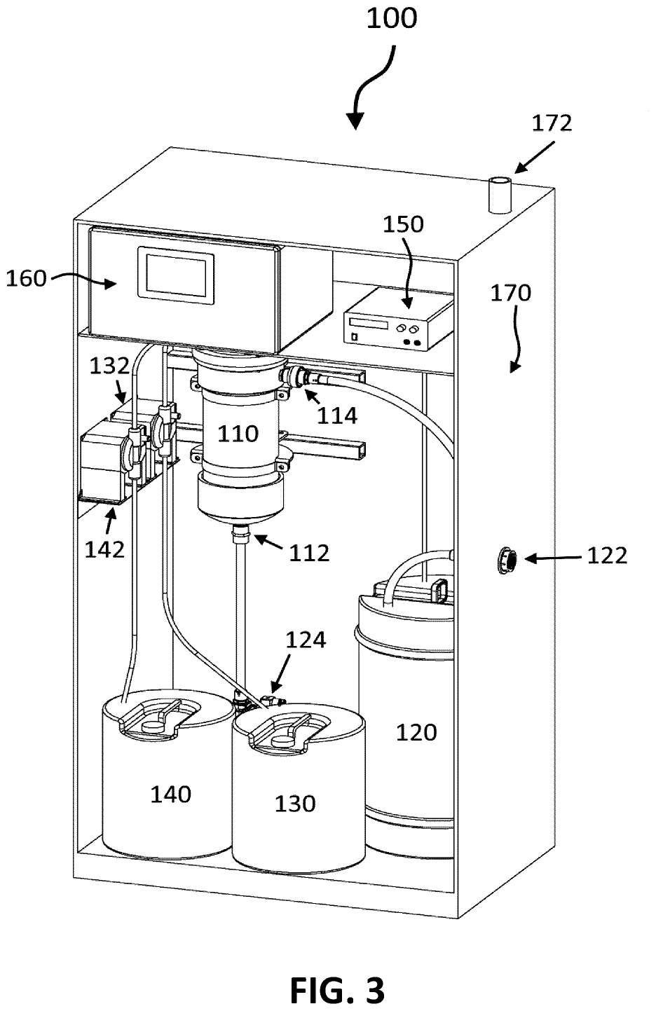

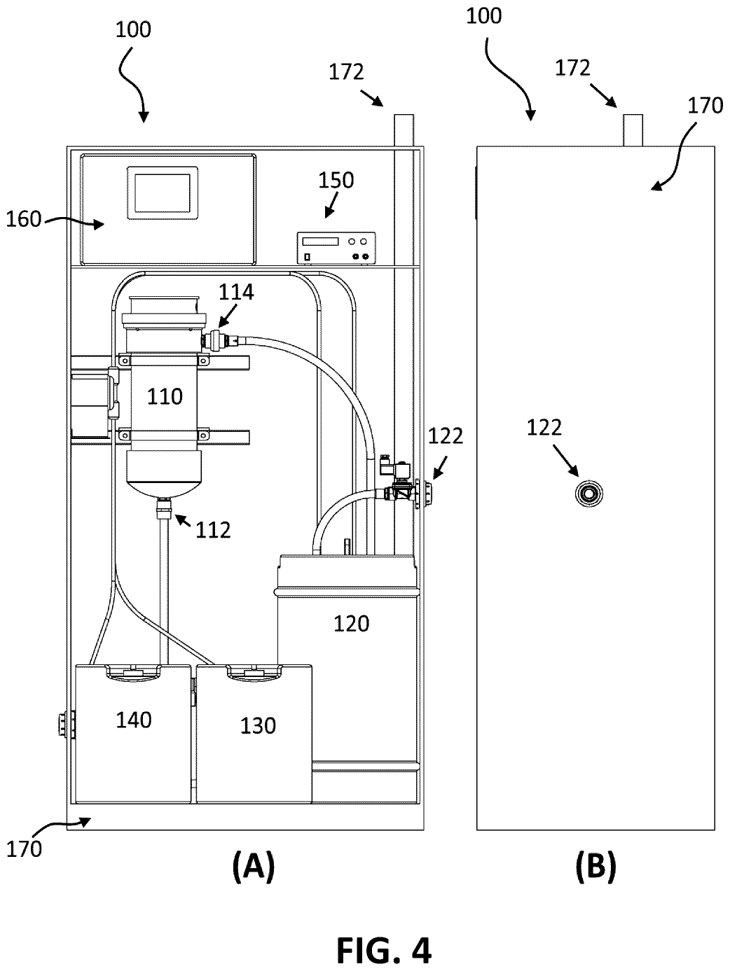

According to a preferred embodiment as the one illustrated on FIGS. 3, 4A and 4B, an apparatus assembly as defined herein may be configured in size for enclosure in a cabinet for safe storage and/or transport thereof.

The apparatus assembly 100 first comprises at least one electrolytic reactor 110, comprising an inlet 112 and an outlet 114, and a first tank 120 fluidly connected to the inlet 112 of the reactor 110. The first tank 120 is configured to receive and contain a first controlled amount of an aqueous solution. The aqueous solution is preferably water, even more preferably tap water. The first controlled amount of the aqueous solution is provided by a water inlet 122, connected to a water source (not shown).

The apparatus assembly 100 also comprises a second tank 130 fluidly connected to the first tank 120 and configured for providing a second controlled amount of an acidic solution to the first tank. For example, 2 to 10 ml, more preferably about 7 ml, of a 10% acetic acid solution for every liter of the aqueous solution in the first tank.

The apparatus assembly 100 also comprises a third tank 140 fluidly connected to the first tank 120 and configured for providing a third controlled amount of a brine solution to the first tank 120. The equivalent of 2 to 8 g, more preferably about 5 g, of NaCl per liter of aqueous solution can be injected. As aforesaid, the apparatus assembly 100 may comprise only one second tank containing both the acidic and brine solutions and fluidly connected to the first tank for providing a second controlled amount of a mixture of the acidic and brine solutions.

As shown in FIGS. 3 and 4, the outlet 114 of the reactor 110 is also fluidly connected to the first tank 120 forming as such a reaction loop in which the first controlled amount of an aqueous solution, the second controlled amount of brine solution and the third controlled amount of acidic solution received by the first tank 120 are mixed together while circulating inside the reaction loop forming as such a reactive solution which then reacts while circulating through the electrolytic reactor 110 where the HOCl is formed. The apparatus assembly can be previously calibrated for estimating the time necessary for transforming the different ingredients into HOCl and obtaining a HOCl solution with a given concentration of HOCl. The given concentration of HOCl in the HOCl solution may range from about 330 ppm to about 460 ppm. “Calibrating” the apparatus assembly consists in knowing parameters including: total volume of water circulating in the reaction loop, the volumes/concentrations of acidic and NaCl solutions to inject in the loop, the speed of the flow of ingredients circulating in the loop, the nature of the electrolytic reactors, and the current applied to the electrodes, in order to estimate when the reaction is over and the HOCl solution is ready.

The apparatus assembly 100 also comprises a pump 124 (partially shown on FIG. 1) operatively connected to the reaction loop for circulating the reactive solution into the reactor 110 and the reaction loop.

The electrolytic reactor 110 of the apparatus assembly 100 is preferably a vertical reactor comprising at least one anode and at least one cathode operatively connected to a first electric power supply 150 providing a continuous current to the anode(s) and cathode(s) to electrolyze the reactive solution flowing through the reactor from a bottom section comprising the inlet 112 to a top section comprising the outlet 114 for the production of HOCl.

The apparatus assembly 100 also comprises a control unit 160 operatively connected to the reaction loop and the pump 124 for controlling the production of HOCl. In a preferred embodiment, the control unit 160 is configured to be operatively connected to a remote monitoring station for monitoring the apparatus assembly 100 from a distant location, such as for instance, a SaaS (software as a service) system.

In a preferred embodiment, the apparatus assembly 100 comprises a first dosing pump 132 operatively connected to the control unit 160, and located upstream the first tank 120 for injecting the second controlled amount of acidic solution into the first tank.

The apparatus assembly 100 preferably comprises a second dosing pump 142 operatively connected to the control unit 160, and located upstream the first tank 120 for injecting the third controlled amount of brine solution into the first tank 120.

In a preferred embodiment, the apparatus assembly 100 comprises at least one probe (not shown) operatively connected to the control unit 160 and the reaction loop for monitoring different parameters of the solution inside the reaction loop. The probe(s) are preferably monitored by the control unit 160 and a computer (not shown) used for registering the data and sending instruction to the control unit.

The parameters are typically the pH of the reactive solution, the concentration of free active chlorine (FAC) produced in the reactor, and the temperature of the reactive solution. For instance, the reaction inside the reaction loop will be deemed complete when the pH is between about 5 and 7, preferably between 5.5 and 6.

The apparatus assembly 100 also comprises a safety valve (not shown) operatively connected to the reaction loop for shutting off the flow of the reactive solution.

As depicted in FIGS. 3 and 4, the apparatus assembly 100 also comprises a cabinet 170 for safely storing and optionally transporting the apparatus assembly, the cabinet 170 being preferably OSHA compliant. The cabinet is also compliant with any other regulatory body governing the commercial use in a given jurisdiction.

In a preferred embodiment, the apparatus assembly 100 comprises a chimney 172 fluidly connected to the top section of the first tank for evacuating gas, for example hydrogen gas (H₂), from the tank 120 outside the cabinet 170.

In another embodiment, the assembly may comprise a number N of electrolytic reactors, with N≥2, disposed in a parallel configuration or in series, the number N being selected in accordance with a volume of HOCl solution to be produced.

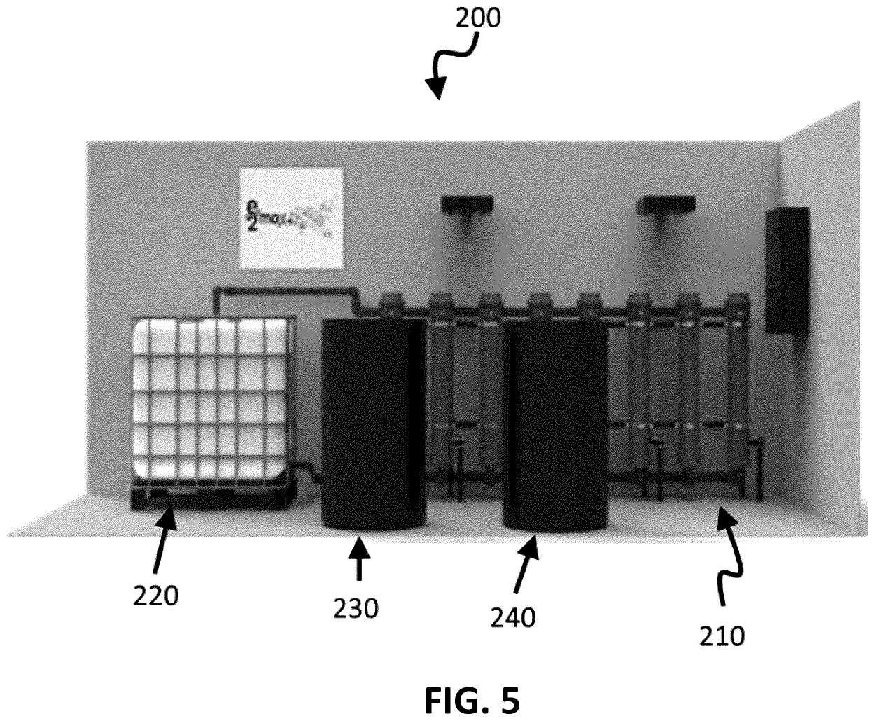

As illustrated in FIG. 5, the assembly 200 has a row of eight electrolytic reactors (N=8) 210 disposed in a parallel configuration.

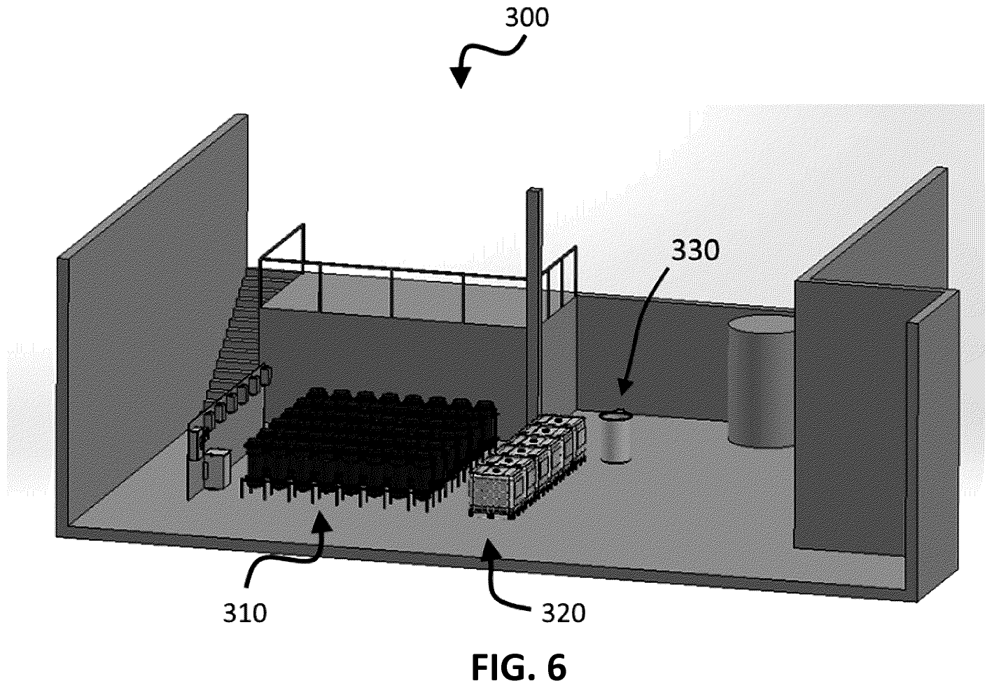

FIG. 6 illustrates an apparatus assembly 300 with 6 rows of 8 reactors giving a total of 48 (N=48) electrolytic reactors 310, also disposed in a parallel configuration or in series. Each row of reactors forms a reaction loop with a respective first tank 320.

A single reactor will typically produce about 50 liters of the HOCl solution per hour. FIG. 5 represents an embodiment wherein the HOCl solution is produced in larger volumes, for example 800 L/hour, in an industrial setting. FIG. 6 illustrates an even greater production capacity of 8,000 L/hour.

Optionally, the first tank 220, 320 may be protected by a metal cage to reinforce the first tank and ease transportation. The second 230 and third 240 tanks shown on FIG. 5 are typically vertical drums fluidly connected to the first tank 220. In FIG. 6, the second and third tanks are combined in one tank 330 providing a mixture of acidic and brine solution.

### The Method:

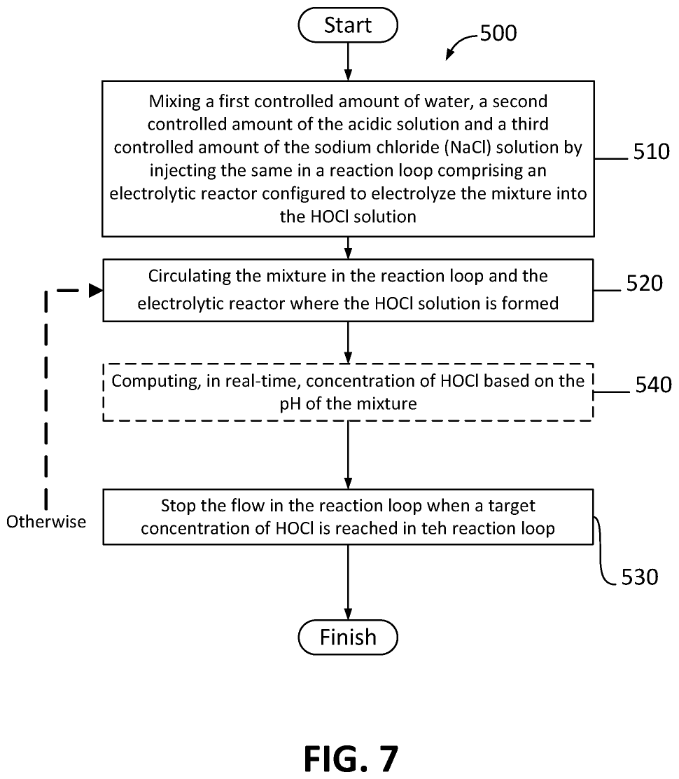

The invention is yet further directed to a method 500 for the electrolytic production of a hypochlorous acid (HOCl) solution from water, an acidic solution and a sodium chloride (NaCl) solution, such as the one illustrated on FIG. 7.

The method 500 first comprises the step of mixing a first controlled amount of water, a second controlled amount of the acidic solution and a third controlled amount of the sodium chloride (NaCl) solution by injecting 510 the same in a reaction loop comprising an electrolytic reactor configured to electrolyze the mixture into the HOCl solution. The method 500 further comprises circulating 520 the mixture in the reaction loop and the electrolytic reactor where the HOCl solution is formed. The given concentration of HOCl is maximum at about 460 ppm when produced.

The method also comprises stopping 530 the reaction loop when the given concentration of HOCl solution is reached.

In a preferred embodiment, the method comprises storing the HOCl solution as produced in the water tank for use of the solution. Since the control unit is configured to be operatively connected to a remote monitoring station, the control unit will alert the user when a batch of HOCl solution is ready.

During production of the hypochlorous acid (HOCl) solution, the method may preferably comprise computing 540 the concentration of HOCl (e.g., real-time computing of measurement(s) such as pH of the mixture to obtain the concentration; lookup measurement(s) in known relation to the concentration; etc.). The concentration of FAC may eventually be measured indirectly using a specific probe located inside the reaction loop and controlled by the control unit.

### Measurement Methodology

Measuring the HOCl concentration directly is not possible, but the accepted method is to measure the free available chlorine (FAC) and pH of the solution, and then to calculate HOCl concentration. The mathematical relation between HOCl, FAC and pH is as follows:

$$HOCl ( ppm ) = \frac{FAC ( ppm ) \cdot \frac{{M}_{{OCl}^{-}}}{{M}_{FAC}}}{{10}^{( pH - 7.53 )} + 1} = \frac{FAC ( ppm ) \cdot \frac{26.23}{35.45}}{{10}^{( pH - 7.53 )} + 1}$$

Clean glassware was used to hold the sample while measurements were made. The HANNA HI 5222 benchtop pH meter with the HANNA HI1131 pH probe were used for pH measuring. The instrument was calibrated with the HANNA calibration solutions (pH 4.01, pH 7.01 and pH 10.1) at the beginning of each day when measurements were made. The HACH DR900 colorimeter and HACH's Test n'Tube™ vials with free chlorine reagent (Set 2105545-CA, method # Method 10102) were used to measure the FAC.

The pH probe will notify the control unit when the pH has reached a value between about 5 and 7, preferably between 5.5 and 6, in order to stop the reaction, which will then signal to the user that the reaction is complete. A temperature probe, such as a thermocouple, may also be used for monitoring the temperature of the reactive solution inside the reaction loop to maintain a temperature preferably between about 20° C. and 25° C.

In a preferred embodiment, the monitoring is done remotely at a distant location using the aforesaid remote monitoring station. The remote monitoring station, such as a SaaS (software as a service) system, will be configured to monitor, in real-time, the production of HOCl and track each batch of HOCl being produced with a lot number to measure quality control parameters and transmit the information remotely using the internet to a computer, installed in a monitoring room. Several apparatus assemblies according to the present invention can be controlled from the same remote monitoring station and room.

The remote monitoring may be accomplished using various sensors, computer software and/or smartphone applications communicating with each other using the internet of things. The system will automatically schedule preventive maintenance appointments with the user and alert him of the need to replenish the brine and acidic solution to avoid delays in production. Since the monitoring system will be able to monitor the usage of HOCl in real-time, the system will be able to predict when a fresh batch will need to be produced using data recorded from past usage. For example, if a workplace is closed over an extended holiday period, the system will advise the user to wait until returning from holidays to produce a fresh batch, even if HOCl is running low, as it recorded usage from past holiday periods. The system will learn to predict peak demand time for HOCl and recommend that a fresh batch should be produced. As such, the system will help reduce waste and lower costs associated with HOCl production, as the system will learn each user's specific cleaning needs tailored to their environment.

The present invention is based on electrochemical reactions taking place inside the reactor (redox) to produce hypochlorous acid (HOCl) and hypochlorite (ClO—), starting from NaCl (salt) and H₂O (water), as follows:

2Cl⁻+2e^{-<->Cl}₂

Cl₂+H₂O<− HOCl+HCl

Cl₂+4OH⁻<−>2ClO⁻+2H₂O+2e⁻

Cl₂+2e²<−22 2Cl⁻

HOCl and ClO⁻ have a different efficacy as disinfectants. Chlorine in the form of HOCl (active free chlorine) is 100 times more effective than chlorine in the form of ClO⁻ (potential free chlorine). Thus, active free chlorine is the most germicidal part of free chlorine. To produce a solution rich in HOCl, the pH of the solution is preferably maintained between 4 and 6. The active free chlorine solution produced by the apparatus and method of the present invention is an analyte at a pH between 5 and 6 with HOCl as active agent. This solution is referred as OXWELL™.

The present invention provides an effective, safe, ecological and economical way to produce hypochlorous acid solutions for use against various pathogens, particularly, severe acute respiratory syndrome coronavirus 2 (SARS-CoV-2).

### Example A

### Production of HOCl Solution (named Oxwell™)

A reaction loop comprising an ECOTHOR (see model disclosed in WO 2021/151195 A1) with a reaction loop of SOL of water (one loop=50 litres of water). 5 g of NaCl per liter of water and 7 mL per liter of water are infected in the loop. The loop pump provides a flow of 17 L/minute. The current applied to the electrodes is of 60 A. The total reaction time is 50 minutes (i.e. a production of 1 L per minute). The HOCl solution as obtained has a concentration of HOCl of between about 430 and 460 ppm for a pH of the HOCl solution as produced of about 5.5.

### Example 1

### Stability of Oxwell™ Produced with the Portable Apparatus Assembly

To maintain the stability of the HOCl solution at least up to 6 months, the pH of the HOCl solution is controlled to be between 5 and 6, more preferably about 5.5 at the time of production.

### Example 2

### Efficacy of Oxwell™ Against Staphylococcus aureus, Pseudomonas aeruginosa and Salmonella enterica

A solution containing either Staphylococcus aureus, Pseudomonas aeruginosa or Salmonella enterica was incubated with an Oxwell# solution containing about 330 ppm (low level concentration) hypochlorous acid for 10 minutes at 20° C. The experimental conditions and results are summarized below.
Exposure Time: 10 minutes
Neutralizer: Letheen Broth +0.1% Sodium Thiosulfate
Actual Exposure Temperature: 20±1° C. (20.0° C.)

### Sample 1

Pseudomonas aeruginosa=1/60 subculture tubes demonstrated growth of the test organism.
Staphylococcus aureus=0/60 subculture tubes demonstrated growth of the test organism.
Salmonella enterica=0/60 subculture tubes demonstrated growth of the test organism.

### Sample 2

Pseudomonas aeruginosa=0/60 subculture tubes demonstrated growth of the test organism.

Staphylococcus aureus=0/60 subculture tubes demonstrated growth of the test organism.

Salmonella enterica=0/60 subculture tubes demonstrated growth of the test organism.

### Sample 3

Pseudomonas aeruginosa=0/60 subculture tubes demonstrated growth of the test organism.

Staphylococcus aureus=0/60 subculture tubes demonstrated growth of the test organism.

Salmonella enterica=0/60 subculture tubes demonstrated growth of the test organism.

The number of positive samples was then assed for the presence of bacteria growth. No colonies of either Staphylococcus aureus or Salmonella enterica could be observed after 10 minutes incubation with Oxwell™ whereas Pseudomonas aeruginosa was reduced by more than 99% (1/180 subculture tubes demonstrated growth). These results indicate that OXWELL™ is an effective disinfectant against all of the bacteria tested. OXWELL™ also eliminates 99.99% of H1N1 and human coronavirus with a contact time of about 1 minute.

Another aspect of the present invention is directed to providing the material and equipment to enable a user to produce up to 1 L/minute of a HOCl solution on-site, by combining sodium chloride, an acid, water, and electrolysis (ECOTHOR™ or the like). The solution can be applied on wipes to clean surfaces, fog apparatuses to disinfect larger areas such as large manufacture, hospitals, gyms and office spaces.

Reference is now made concurrently to FIG. 2, FIG. 7 and FIG. 8, which show a logical modular representation of a system 1000 for electrolytic production of hypochlorous acid, in accordance with the teachings of the present invention. The system 1000 provides an exemplary modular view of the control unit 13, which may be involved in the electrolytic production of hypochlorous acid. The system 1000 may also comprise a remote monitoring station 1200. In a preferred embodiment, the control unit 13 exchanges data with the remote monitoring station 1200 and the control unit 13 is therefore able to send one or more message (e.g., reaction loop is active, reactor chamber is inactive, pump problem, a batch of HOCl solution is ready, etc.) and receive one or more commands (e.g., activate the system, activate the reaction loop, stop the system, etc.).

In the depicted example of FIG. 8, the control unit 13 comprises a memory module 1120, a processor module 1130 and a network interface module 1140. The processor module 1130 may represent a single processor with one or more processor cores or an array of processors, each comprising one or more processor cores. The memory module 1120 may comprise various types of memory (different standardized or kinds of Random Access Memory (RAM) modules, memory cards, Read-Only Memory (ROM) modules, programmable ROM, etc.). The network interface module 1140 represents at least one physical interface that can be used to communicate with other network nodes. The network interface module 1140 may be made visible to the other modules of the control unit 1100 through one or more logical interfaces. The actual stacks of protocols used by the physical network interface(s) and/or logical network interface(s) 1142, 1144, 1146, 1148 of the network interface module 1140 do not affect the teachings of the present invention. The variants of processor module 1130, memory module 1120 and network interface module 1140 usable in the context of the present invention will be readily apparent to persons skilled in the art.

A bus 1170 is depicted as an example of means for exchanging data between the different modules of the control unit 13. The present invention is not affected by the way the different modules exchange information between them. For instance, the memory module 1120 and the processor module 1130 could be connected by a parallel bus, but could also be connected by a serial connection or involve an intermediate module (not shown) without affecting the teachings of the present invention.

Likewise, even though explicit mentions of the memory module 1120 and/or the processor module 1130 are not made throughout the description of the various embodiments, persons skilled in the art will readily recognize that such modules are used in conjunction with other modules of the control unit 13 to perform routine as well as innovative steps related to the present invention.

The control unit 13 may also comprise an optional Graphical User Interface (GUI) module 1150 comprising one or more display screen(s) forming a display system, for the control unit 1100. The display screens of the GUI module 1150 could be split into one or more flat panels, but could also be a single flat or curved screen visible from an expected user position (not shown). Skilled persons will readily understand that the GUI module 1150 may be used in a variety of contexts not limited to the previously mentioned examples.

The system 1000 may comprise a data storage system 1500 that comprises data related to electrolytic production of hypochlorus acid and may further log data while the production is performed. FIG. 8 shows examples of the storage system 1500 as a distinct database system 1500A, a distinct module 1500B of the control unit 1100 or a sub-module 1500C of the memory module 1120 of the control unit 1100. The storage system 1500 may also comprise storage modules (not shown) on the remote monitoring station 1200. The storage system 1500 may be distributed over different systems A, B, C and/or the remote monitoring station 1200 or may be in a single system. The storage system 1500 may comprise one or more logical or physical as well as local or remote hard disk drive (HDD) (or an array thereof). The storage system 1500 may further comprise a local or remote database made accessible to the control unit 1100 by a standardized or proprietary interface or via the network interface module 1140. The variants of the storage system 1500 usable in the context of the present invention will be readily apparent to persons skilled in the art.

A measurement input module 1160 and a control module 1161 are provided in the control unit 13. The measurement input module 1160 and the control module 1161 will be referred to hereinbelow as distinct logical modules, but skilled person will readily recognize that a single logical module may have been shown instead.

In some embodiment, an optional external input/output (I/O) module 1162 and/or an optional internal input/output (I/O) module 1164 may be provided with the measurement input module 1160 and the control module 1161. The external I/O module 1162 may be required, for instance, for interfacing with one or more pumps (e.g., 7, 21, 21a, 21b), one or more probes (e.g., 23) and/or one or more electrolytic reactor (e.g., 3). The internal input/output (I/O) module 1164 may be required, for instance, for interfacing the control unit 13 with one or more instruments or controls (not shown) typically used in the context of electrolysis production (e.g., standard dial or control system). The I/O module 1164 may comprise necessary interface(s) to exchange data, set data or get data from such instruments or controls.

The measurement input module 1160 and the control module 1161 are tightly related to the electrolytic production of the hypochlorus acid. In the example of the system 1000, the measurement input module 1160 and the control module 1161 may be involved in various step of the method 500. For instance, injecting 510 the controlled amounts in the reaction loop involves selectively activating, by the control module 1161, one or more of the pumps 19, 19a and 19b. Likewise, circulating 520 the mixture in the reaction loop and the electrolytic reactor and stopping 530 the reaction loop involve selectively activating, by the control module 1161, the pump 7.

During production of the hypochlorous acid (HOCl) solution, the measurement input module 1160 may obtain one or more measurements and may exchange data with the processor module 1130 for computing 540, in real-time, the concentration of HOCl (e.g., based on the pH of the mixture). The one or more measurements may be obtained automatically (e.g., from the probe 23, from the electrolytic reactor 3, . . . ) and/or may be provided manually (e.g., from the GUI module 1500). The one or more measurements may be, for instance, the pH of the circulating mixture, obtained directly or indirectly (through the I/O module 1162) from one or more measurement tools (e.g., the probe 23, . . . ).

A computed 540 concentration of HOCl and/or the one or more measurements themselves may be used by the control unit 13 to determine that a target concentration of HOCl has been reached and, therefore, to stop 530 the reaction loop.

Various network links may be implicitly or explicitly used in the context of the present invention. While a link may be depicted or conceived as a wireless link (e.g., Bluetooth, LTE, 5G, . . . ), it could also be embodied as a wired link using a coaxial cable, an optical fiber, a category 5 cable, and the like. A wired or wireless access point (not shown) may be present on the link. Likewise, any number of routers (not shown) may be present and part of the link, which may further pass through the Internet.

The present invention is not affected by the way the different modules exchange information between them. For instance, memory module(s) and processor module(s) could be connected by a parallel bus, but could also be connected by a serial connection or involve an intermediate module (not shown) without affecting the teachings of the present invention.

A computer-implemented method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1) An apparatus assembly for the electrolytic production of a hypochlorous acid (HOCl) solution from water, an acidic solution and a sodium chloride (NaCl) solution, the apparatus assembly comprising:
an electrolytic reactor having an electrically powered electrode assembly inside a reaction chamber; and
a loop pump fluidly connected to the reaction chamber such as to form a reaction loop with the electrolytic reactor;
wherein the reaction loop is configured to receive the water, the acidic solution and the sodium chloride solution which are mixed together therein; and
wherein the electrolytic reactor is configured to electrolyze the mixture of water, acidic solution and the sodium chloride solution through the reaction chamber to form the HOCl solution.

2) The apparatus assembly of claim 1, further comprising a control unit operatively connected to the loop pump for controlling a flow of the mixture circulating in the reaction loop.

3) (canceled)

4) The apparatus assembly of claim 1, wherein the electrolytic reactor is a vertical reactor having the electrode assembly comprising at least one anode and at least one cathode operatively connected to a first electric power supply providing a continuous current to the at least one anode, the vertical reactor having an inlet located adjacent a bottom section of the reaction chamber and an outlet located adjacent a top section of the reaction chamber, the mixture of water, acidic solution and sodium chloride solution circulating from the bottom section to the top section of the reaction chamber.

5) The apparatus assembly of claim 1, wherein the reaction loop further comprises a loop tank fluidly connected to the inlet and outlet of the reactive chamber, the loop tank being configured in size to contain at least a first controlled amount of water, a second controlled amount of the acidic solution and a third controlled amount of the NaCl solution.

6) The apparatus assembly of claim 5, further comprising a reactive tank assembly comprising at least one reactive tank fluidly connected to the reaction loop via at least one reactive dosing pump for providing the second controlled amount of acidic solution, the third controlled amount of NaCl solution or a mixture thereof.

7) The apparatus assembly of claim 6, wherein the reactive tank assembly is fluidly connected to the loop tank of the reaction loop for injecting the second and third controlled amounts of acidic and NaCl solutions in the loop tank.

8) (canceled)

9) The apparatus assembly of claim 7, wherein the reactive tank assembly comprises:
an acid tank fluidly connected to the reaction loop via an acid dosing pump for providing the second controlled amount of acidic solution; and
a salt tank fluidly connected to the reaction loop via a salt dosing pump for providing the third controlled amount of NaCl solution.

10) (canceled)

11) The apparatus assembly of claim 9, further comprising a pH probe operatively connected to the reaction loop for monitoring a pH of the mixture circulating in the reaction loop permitting assessment of a concentration of HOCl in the HOCl solution.

12) (canceled)

13) (canceled)

14) (canceled)

15) (canceled)

16) (canceled)

17) The apparatus assembly according to claim 11,
wherein the reaction loop comprises a number N of electrolytic reactors, with N≥2, disposed in a parallel configuration and/or in series, the number N being determined in accordance with a volume of HOCl solution to be produced.

18) The apparatus assembly of claim 17, wherein the electrode assembly of the electrolytic reactor comprises at least one dimensionally stable anode (DSA).

19) A method for the electrolytic production of a hypochlorous acid (HOCl) solution from water, an acidic solution and a sodium chloride (NaCl) solution, comprising:
mixing a first controlled amount of water, a second controlled amount of the acidic solution and a third controlled amount of the sodium chloride (NaCl) solution by injecting the same in a reaction loop comprising an electrolytic reactor configured to electrolyze the mixture into the HOCl solution; and
circulating the mixture in the reaction loop and the electrolytic reactor where the HOCl solution is formed.

20) The method of claim 19, further comprising controllably activating, by a control unit, one or more pumps for mixing the first, second and third controlled amounts.

21) The method of claim 20, further comprising mixing the second controlled amount of the acidic solution and a third controlled amount of the sodium chloride (NaCl) solution before injecting the same in the reaction loop.

22) The method of claim 21, further comprising measuring a pH of the mixture circulating in the reaction loop.

23) (canceled)

24) The method of claim 19, further comprising stopping the circulation of the mixture in the reaction loop when a given concentration of HOCl has been reached.

25) The method of claim 24, wherein the given concentration of HOCl is obtained at a pH between 5 and 7.

26) (canceled)

27) The method of claim 25, wherein the acidic solution comprises acetic acid (CH₃COOH).

28) The method of claim 27, wherein the controlled amount of acidic solution comprises from to 2 to 10 ml of a 10% acetic acid solution per liter of water in the reaction loop.

29) (canceled)

30) The method of claim 29, wherein the third controlled amount of NaCl solution is obtained from a brine solution for providing an equivalent of from 2 to 8 g of NaCl per liter of water in the reaction loop.

31) The method of claim 30, wherein the brine solution provides an equivalent of about 5 g of NaCl per liter of water in the reaction loop.

32) (canceled)

33) (canceled)

34) (canceled)

35) A disinfecting solution comprising the HOCl solution produced with the apparatus assembly as claimed in claim 1 or by the method as claimed in claim 19, wherein the disinfecting solution when produced comprises 330-460 ppm HOCl at a pH between 5 and 6, the solution being stable at least up to 6 months after being produced.
